(19) United States
(12) Patent Application Publication
(10) Pub. No.: US 2016/0289948 A1
(43) Pub. Date: Oct. 6, 2016

(54) SEWER OVERFLOW DETECTOR

(71) Applicant: TYLER J. RASMUS, Eagle Bridge, NY (US)

(72) Inventor: TYLER J. RASMUS, Eagle Bridge, NY (US)

(21) Appl. No.: 14/675,406

(22) Filed: Mar. 31, 2015

(51) Int. Cl. E03F 7/00; G08B 21/18

(52) U.S. Cl. CPC E03F 7/00; G08B 21/182

(57) ABSTRACT

This product is designed to alert building owners that there is a dangerous sewage back-up condition occurring. Once a sewage back-up has occurred, it is not only annoying, but it also could cost thousands of dollars. There is no existing product that a building owner can buy, at any money, to alert them that the sewage system is backing up into the building. This system will work for either in-ground septic systems or town/city sewer systems. The Sewer Overflow Detector system can be installed in 15 minutes by plumber or building owner in the basement or crawl space on sewer line where it enters the building. This devise could eventually be priced like smoke detectors, after manufacturing becomes streamlined. The described installation would also allow for a sewer clean out for access for plumber or septic line cleaner to clean out system.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF INVENTION

This invention relates to Home Protection Devices. Similar to Smoke Detectors or Carbon Monoxide Detectors. This Invention is a “Sewer Overflow Detector”.

### DISCUSSION OF RELATED ART

Currently there are no devices available to home owners to warn them of a potential dangerous and expensive sewer back-up into the living space of the home. There is no way to tell when your homes sewer line has become blocked. This condition leads to the eventual problem of sewer waters flooding into your home at the lowest sewer inlet of your home. It could be through a shower drain or a toilet backing up and over flowing. Not only is this condition very annoying, but it could cost thousands of dollars of damage. If it were to happen while you were away, it could make your home unlivable. Filling your home with odor, bacteria, water damage and mold.

There are some systems available for this condition. One system is used when installing a pump station on your property. It is a float system that is installed for the operation of the pump(s) themselves. One float switch is to turn the pump off near the bottom of the tank. The next float switch will turn the pump on when it reaches a certain volume of liquids. The last float switch is to set off an alarm box inside the house to alert the owner that there is a potential problem. In theory, this float switch could be installed into a home septic system to accomplish a overflow alarm. This system would cost hundreds of dollars to install. The cost of a plumber, electrician, excavator and materials could cost as much as a thousand dollars. This is to expensive for the average home owner. It also would not work if you were connected to a town/municipal sewer system. There is also a very complex system available on the market that is very large. This system requires professional installation and would seem to take hours to days to install. This system also takes a lot of room, appearing to be 4 feet long and 18″ tall. Many homes would not have the space to allow for such a system. This system would cost several hundreds to thousands to install.

Therefore there is a need for an affordable detection device that alerts the homeowner that a potentially costly and dangerous overflow condition is possible. This device is designed to be installed in the basement or crawlspace at the lowest possible level in the home. This will in turn set off the alarm well before the sewage back-up can overflow onto your finished living space. The idea would be, that as soon as you hear the alarm, you would stop using water in the house to see if the alarm goes off shortly thereafter. Then you could monitor the alarm to see if it goes on again as soon as you use the household water again. At this point you would call your plumber or your local sewer line cleaner (jet line or auger).

### SUMMARY OF INVENTION

The present invention includes several individual elements made specifically for the sewer overflow detector. The other elements included with this device shall be specially made to fit together for proper fit and operation.

The specially molded PVC base element of this device shall be made to fit snuggly with standard manufactured 4″ schedule 40 PVC plumbing threaded connections. The base piece shall be molded with a solid bottom of similar thickness to side walls. It will also have molded lugs spaced evenly around the circumference of the base to be used to wrench unit into threaded connection. The base unit shall have molded catches to interconnect with the cap piece for a twist and lock connection. The base of the unit will be drilled to allow on/off button to be connected though the base to minimize possibility of pressurized leak through of sewer back flow.

The speaker cap piece shall be made of thin wall plastic similar to smoke detector cover piece. The cap piece shall be molded to fit a 2½″ 9 volt speaker/siren snuggly so that a minimum of adhesive will be needed to attach speaker. The cap piece will be made to have several twist lock catches molded into plastic piece for quick and easy access and battery replacement. The cap will also be drilled for a test button.

There will be a bendable insert which should be made of a thin pliable plastic that is stiff enough to hold up elements over time. The battery and PCB board shall be riveted to the insert Once the insert is inside base unit it should fit tightly to the inside edge of the base unit. In so doing it will allow plenty of room for the wires and on/off button to fit and function inside the base unit,

The PCB board will be a simple widely available circuit board which can be bought for simple push button alarm circuits. This board could also have a LED flashing light to indicate power supply and the ability to plug in a 1.5 volt transformer for long term power supply.

The battery holder shall be a molded plastic carrier with 3 attachment points to be riveted to the bendable insert. The holder should be slightly larger than a standard 9 volt battery for easy insertion and removal.

The rubber membrane shall be molded of soft flexible latex product. The membrane shall be molded to have a flat bottom edge for easy adhesive attachment or thermal bonding to the molded base piece. The membrane and adhesive attachment should be strong enough to withstand 20 psi of back pressure. The product is made for early detection of a sewer back-up, not for a long term pressure situation. There should only be pressure exerted in a sewer back-up situation. There should be no pressure applied in normal day to day conditions.

The hinged flap is to be made of light gage steel. 26-32 gage. It will be in a sealed environment so it should not be able to rust easily. It will have a easy working barrel hinge to move freely. The wide flap is there to help push on/off button in the case of a sewer back-up. When a sewer back-up situation first starts there would not be that much pressure pushing against the membrane and on/off button. This flap would help push button with less pressure. As the head pressure builds, based on the back-up going higher and higher up the pipes, the button will push easier. After a certain amount of pressure builds the other condition that could happen is the button could penetrate the rubber membrane, the flat steel flap should disperse that pressure over a wider area. This would make it less likely to puncture the membrane. Caution shall be taken in insure there are no sharp edges of corners on steel flap.

### DESCRIPTION OF THE DRAWINGS

FIG. 1 is a perspective view of the device illustrated with the cap unscrewed from the base. The view also shows some of the interior elements.

FIG. 2 is a cross sectional view thru device and standard pipe connection in normal mode (alarm not sounding). This section of pipe would be located in the basement (or lowest location of building) before sewer line leaves the building. The “Sewer Overflow Detector” would be screwed into a typical 4″ PVC clean out in this location.

FIG. 3 is the same cross section thru device and standard pipe connection (as FIG. 2) in a Sewer Back-up Condition. In this scenario the alarm/siren would be activated and would alert the building owner that the sewer line has backed up into the building (inside sewer line).

FIG. 4 is a view of the molded base piece. Base piece will be made of schedule 40 PVC plastic.

FIG. 5 is a view of the speaker/siren top molded plastic cap piece.

FIG. 6 is a top view of the bendable plastic insert which holds the PCB circuit board and battery holder. This piece is bent into a semicircular cone and slid into base piece.

FIG. 7 is a view of the molded thin rubber membrane that is attached to the bottom of the base piece.

FIG. 8 is a view of a thin metal hinged flap. The flap is to help depress on/off button. It is located under the rubber membrane.

FIG. 9 is an exploded perspective view of the device illustrating how all the separate components fit together.

### DETAILED DESCRIPTION OF PREFERRED EMBODIMENT

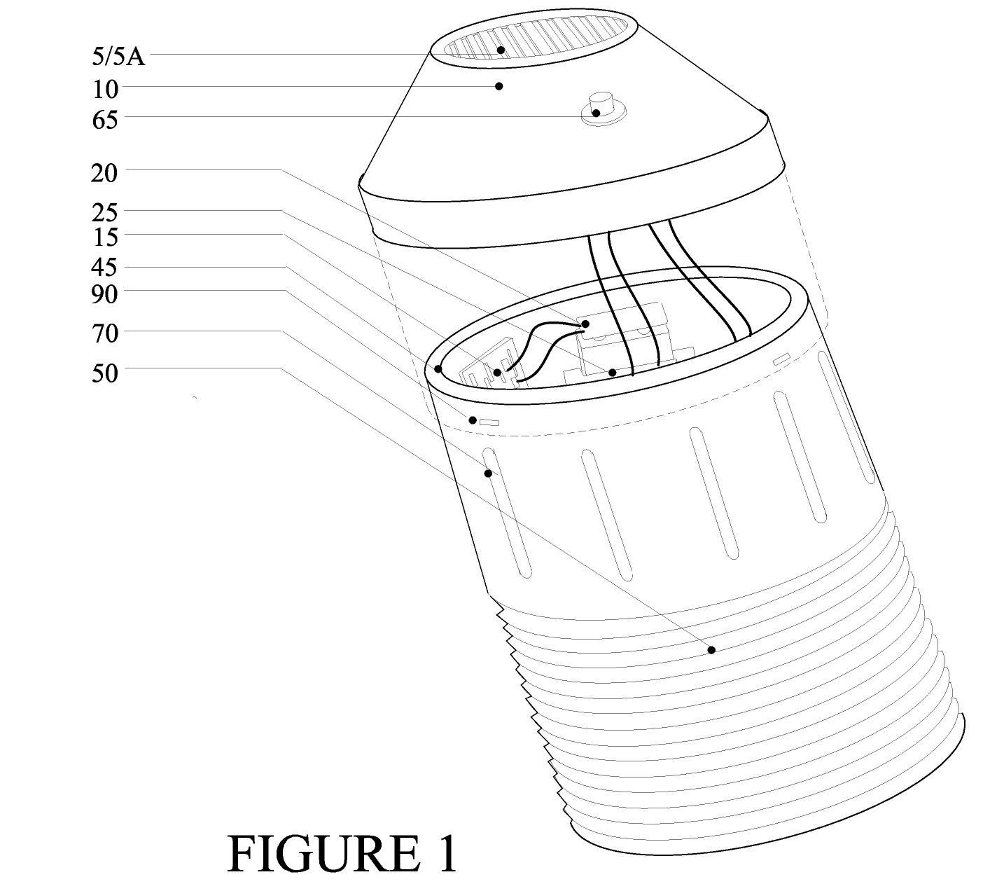

Referring to FIG. 1, illustrated as a perspective view of device. 5 is the louvered cap for speaker/siren to be heard. 10 is thin wall plastic molded cap piece which is removable to access battery and other elements. 65 is the test button. 20 is the 9 volt battery that powers the device (AC adapter would be a good option; 1.5 volt plug in transformer). 25 is the molded battery holder. 15 is the PCB circuit board. 45 is the specially molded PVC schedule 40 base pieces. 90 is the molded registration nubs to twist and lock cap onto base piece. 70 are the molded lugs that allow you to ‘wrench’ base piece into 4″ threaded PVC adaptor. 50 are the molded threads that match the treads of a standard 4″ PVC schedule 40 threaded adaptor,

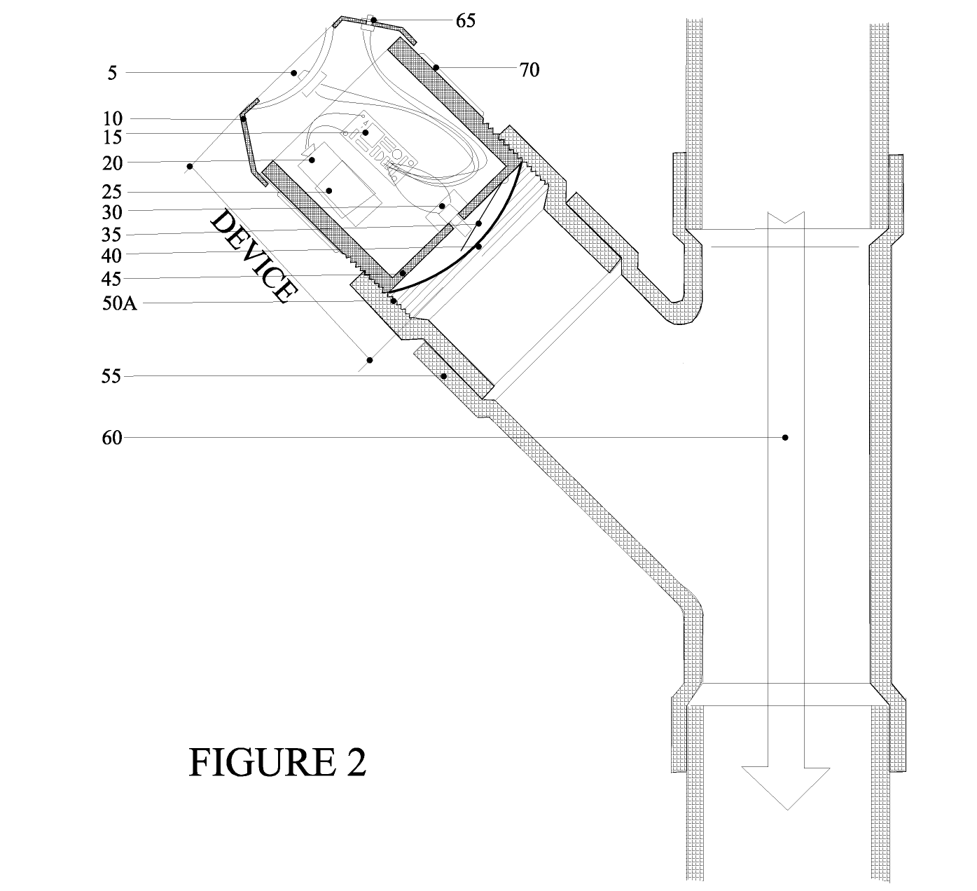

Referring to FIG. 2, illustrated as a cross section of the device inserted into a typical PVC sewer line clean-out. 5 is the speaker/siren inside 10 the molded cap piece. 15 is the PCB circuit board connected to 20 9 volt battery. 25 is the molded battery holder attached to a bendable plastic insert. 30 is the on/off push button which is the activator of the alarm siren. 35 is a hinged thin metal flap which is situated below the alarm on/off button. 45 is the thin rubber membrane which keeps all the electronics moisture and water tight. 50A is the treaded 4″ PVC schedule 40 adaptor readily available at most plumbing supply stores. 55 is a 4″ PVC schedule 40 standard ‘y’ connection. (if sewer line is a 3″ PVC, a 3″×4″ adapter would be used) 60 is sewer line with normal flow. 65 is the test button to allow owner to test battery and siren operation. 70 is molded lugs on side of base piece to allow device to be ‘wrenched’ into threaded connection.

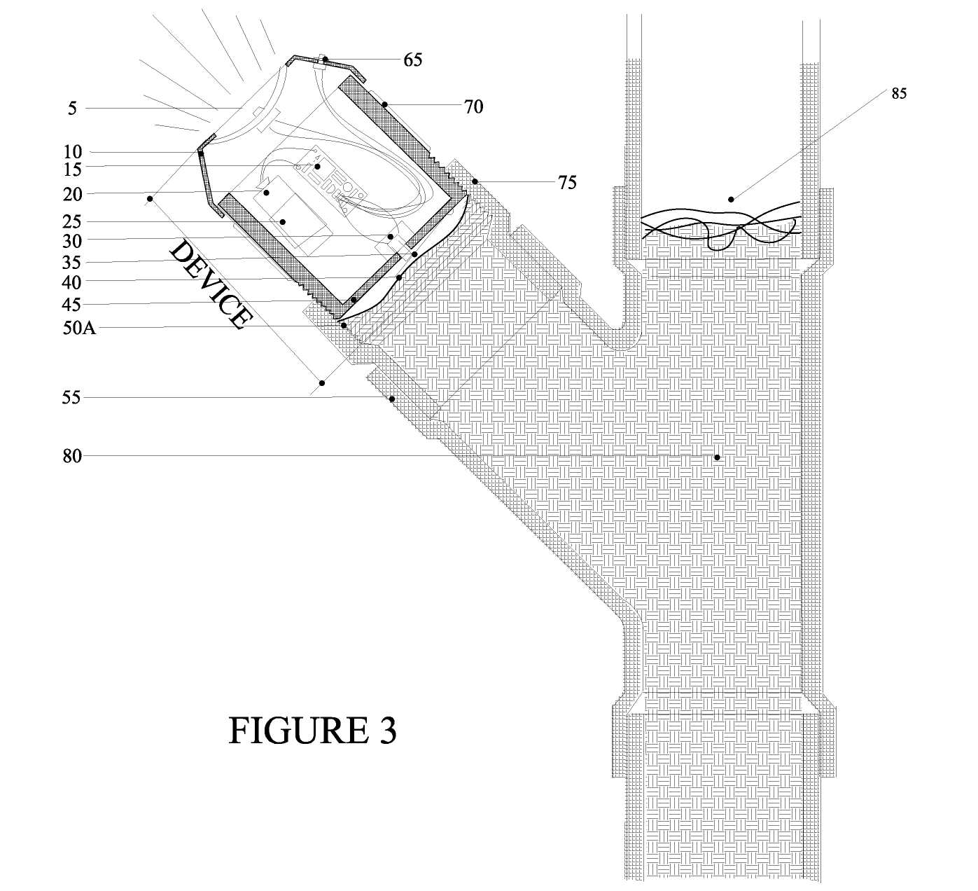

Referring to FIG. 3, illustrated as a cross section in the same sewer line connection in a sewer back-up condition. Most indicators are the same as FIG. 2 except; 5 is speaker/siren in alarm mode alerting inhabitants that the sewer line is backing up into the building. 30 is the on/off alarm button in depressed or “ON” position. 35 is the hinged metal flap that is helping to depress the on/off button with less force then membrane alone, alerting of the back-up condition sooner. 40 is the thin rubber membrane depressed from the pressure of the sewer fluids backing up. 80 is the sewer line backing up the pipe. 85 is the alarm is sounded before the sewer backs up all the way into the building.

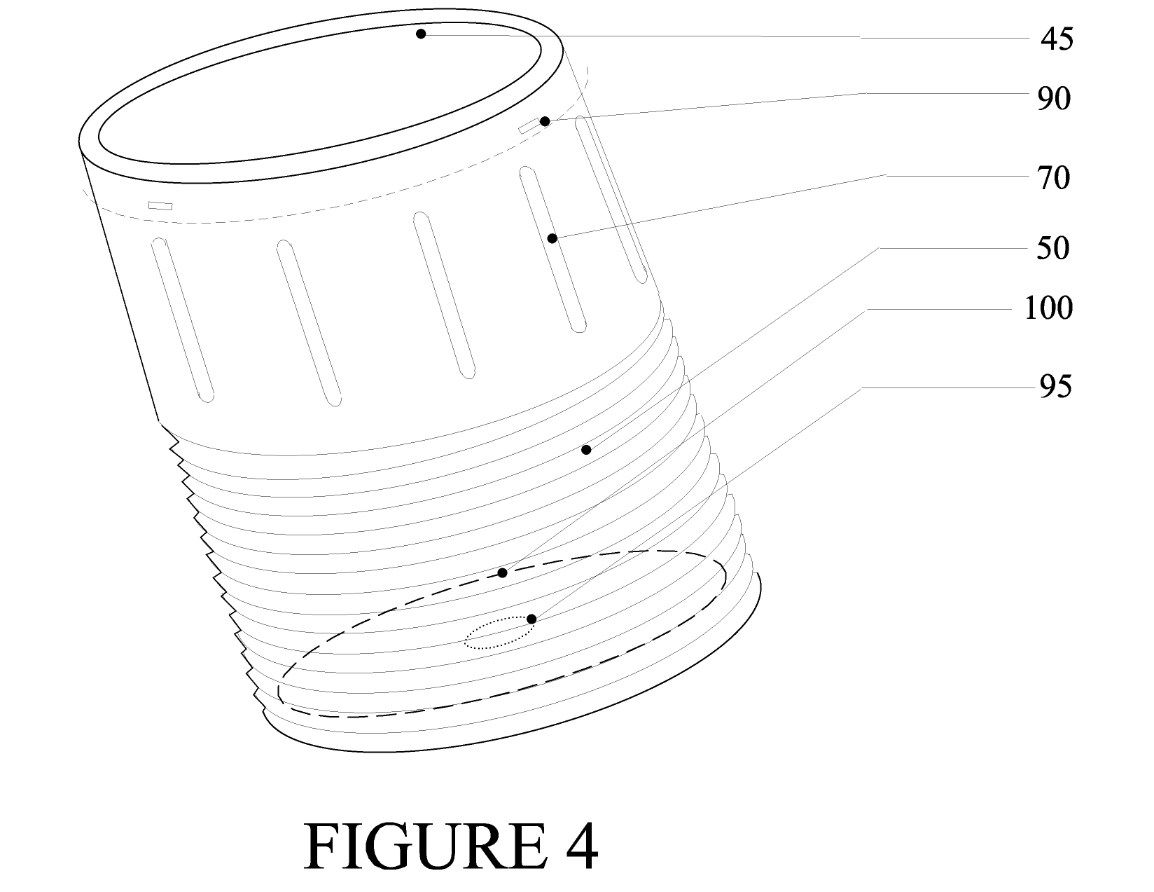

Referring to FIG. 4, illustrated view of specially molded base piece. 45 is the molded base to be made of schedule 40 PVC plastic. 90 is the registration nubs to twist and lock cap piece to base piece. 70 are the molded lugs that allow base piece to ‘wrenched’ into threaded clean-out piece. 50 are the molded treads that should be made to match threads of a standard 4″ schedule 40 PVC adaptor. 95 is a hole drilled in bottom of base to install the alarm on/off button. 100 is the bottom of the base piece to be solid and as thick as the side walls.

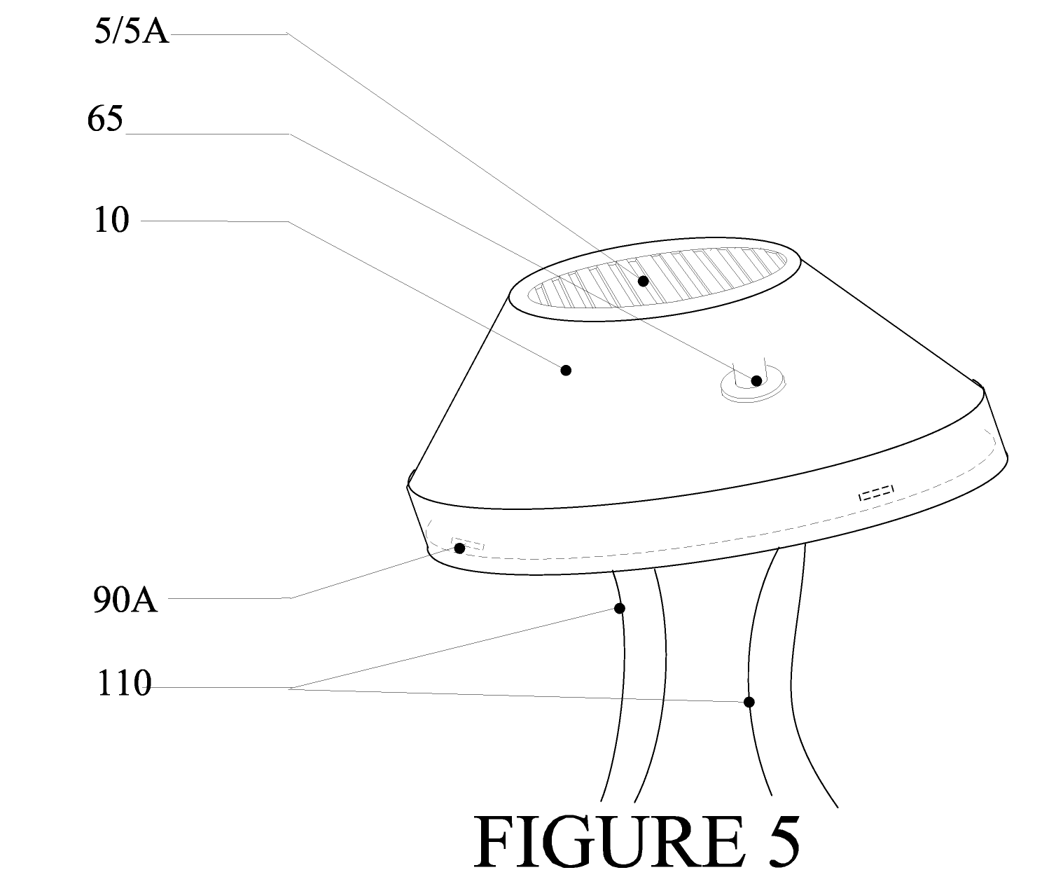

Referring to FIG. 5, illustrated view of the molded plastic cap piece. 5A refers to the molded cap lovers to allow speaker/siren to be heard thru plastic cap. 5 is the speaker/siren below the louvered cap. 65 is the test button. 10 is the thin wall specially molded plastic cap piece. 90A are the registration nubs on inside of cap to twist and lock cap to base. 110 are the lead wires for the speaker/siren and test button; wires are long enough to allow removal of cap without pulling off wires.

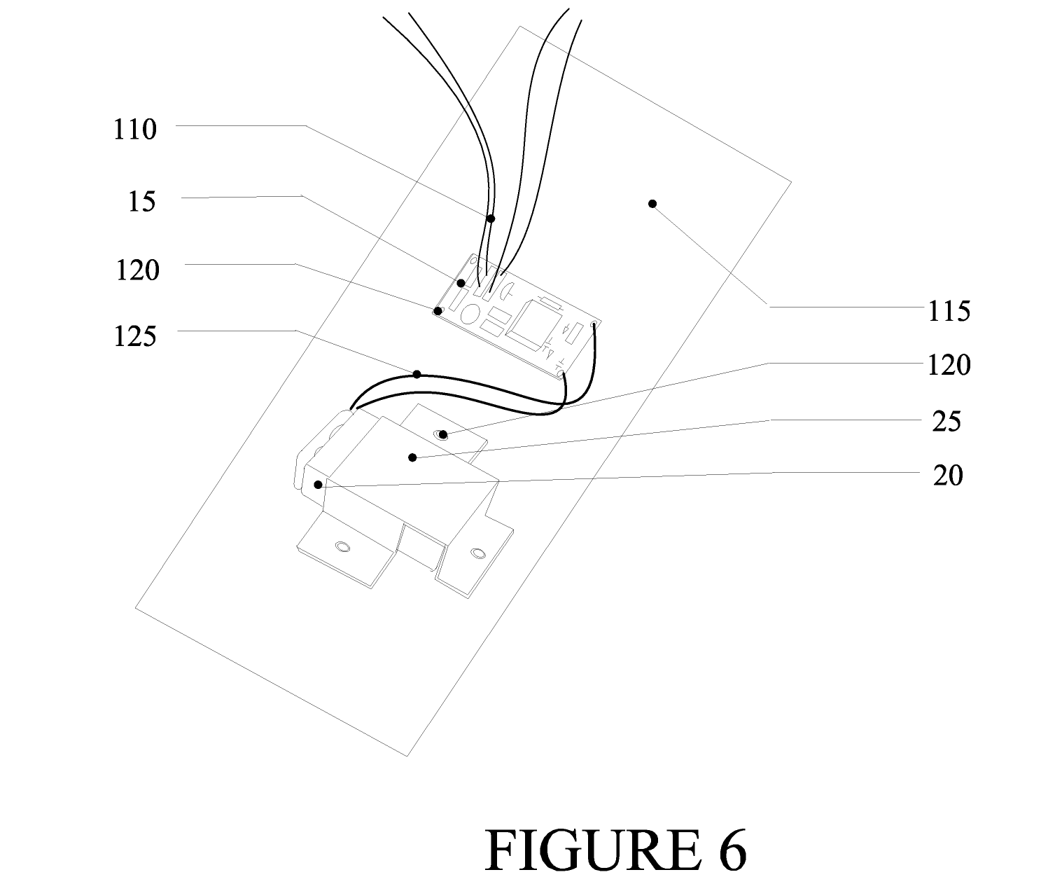

Referring to FIG. 6, illustrated view of the bendable plastic insert. 115 is the flat bendable plastic insert which allows for the attachment of elements on work surface and then inserted into base piece. 120 are rivets to attach battery holder and PCB board to plastic insert. 25 is molded plastic battery holder made to hold a 9 volt battery. 20 is the 9 volt battery that will power the device. 110 are the wire lead to connect to the on/off button, speaker/siren and the test button. 15 is the PCB circuit board that controls the electronics of the device. 125 are the power supply wires that go to the battery.

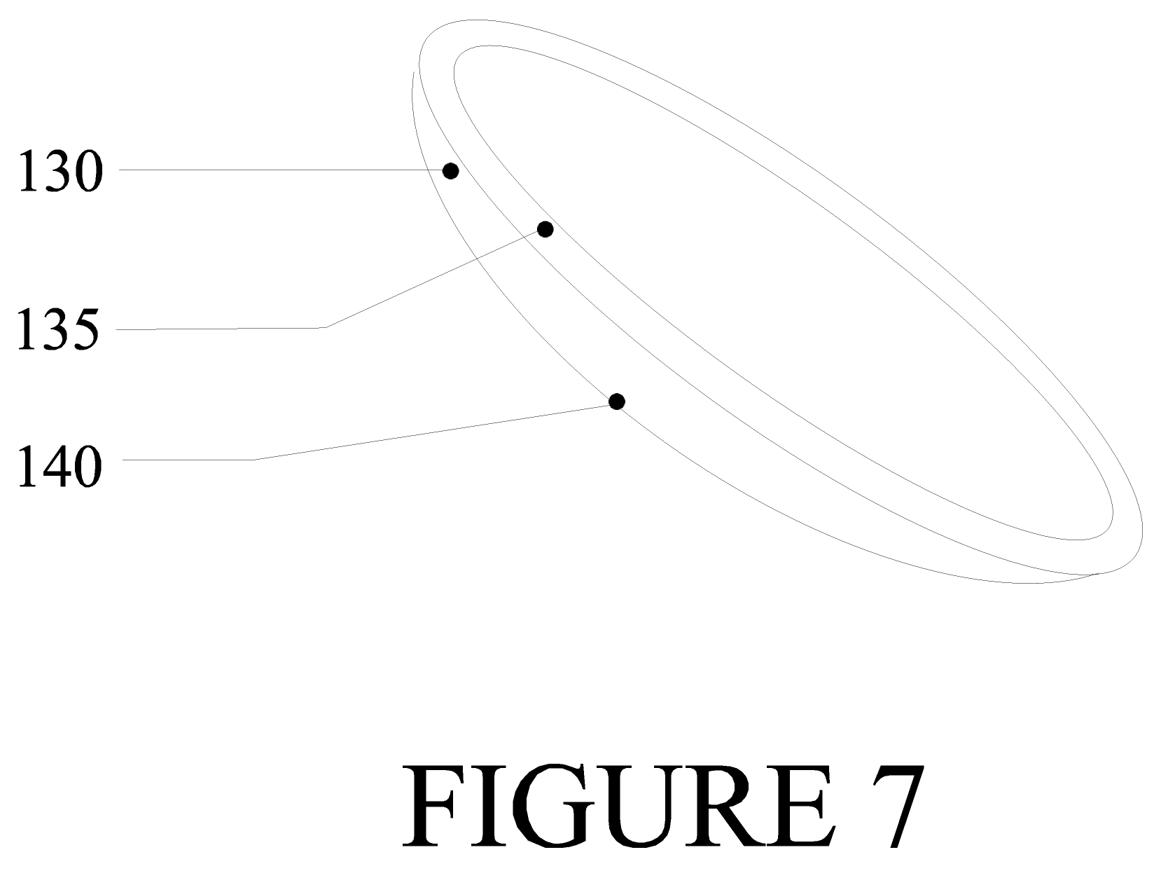

Referring to FIG. 7, illustrated view of thin rubber membrane. 130 is the thin strong rubber membrane that is specially molded to fit the bottom of the base piece. 135 is the flat bottom edge of membrane that allow membrane to be attached with adhesive to the base piece making a good watertight connection. 140 is the arch of the membrane which should be tall enough to allow for the hinged flap inside and on/off button so as to not to set off false alarms.

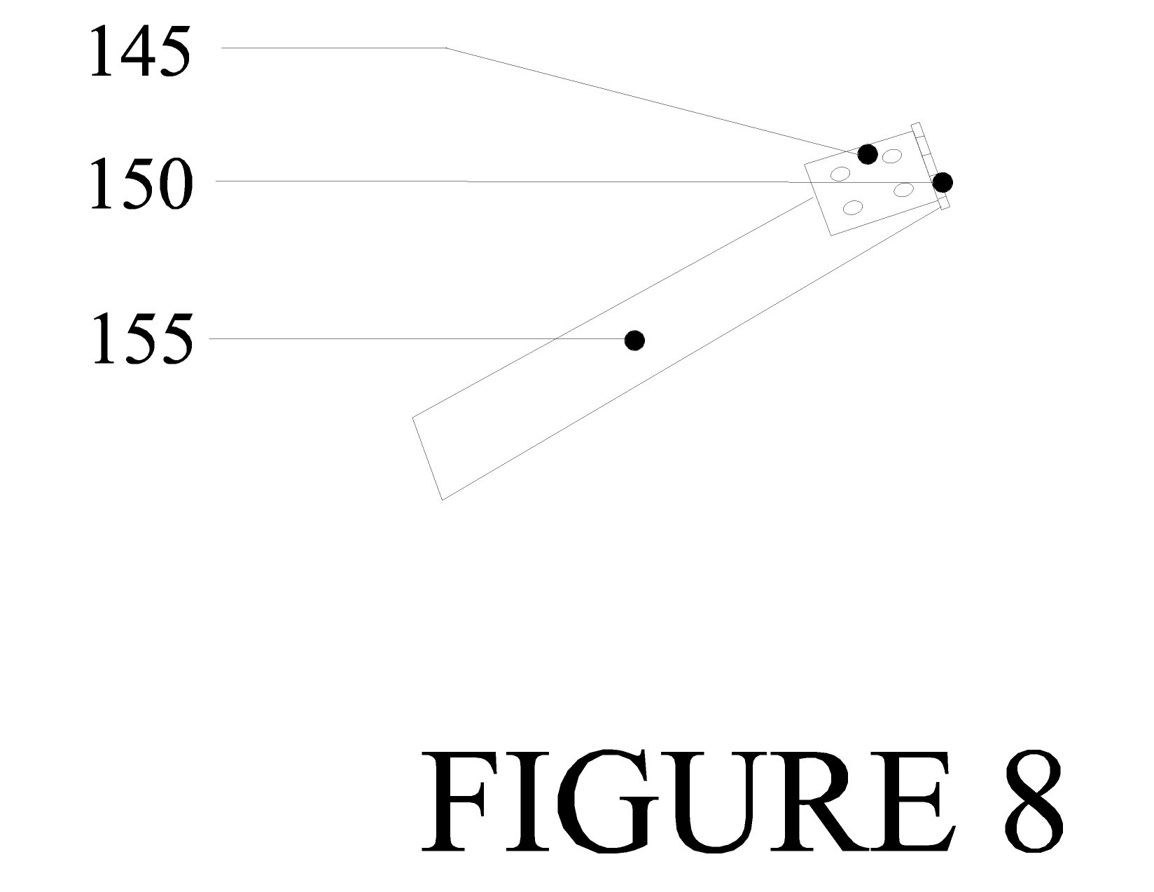

Referring to FIG. 8, illustrated view of hinged thin metal flap. 145 is the short section of flap that would be attached to the base piece of device (attached mechanically to make sure it doesn't fall off). 150 is the hinge barrel that should operate easily. 155 is the thin metal flap that should be just long enough to reach over top of on/off button, (caution will be used to make sure there are no sharp edges)

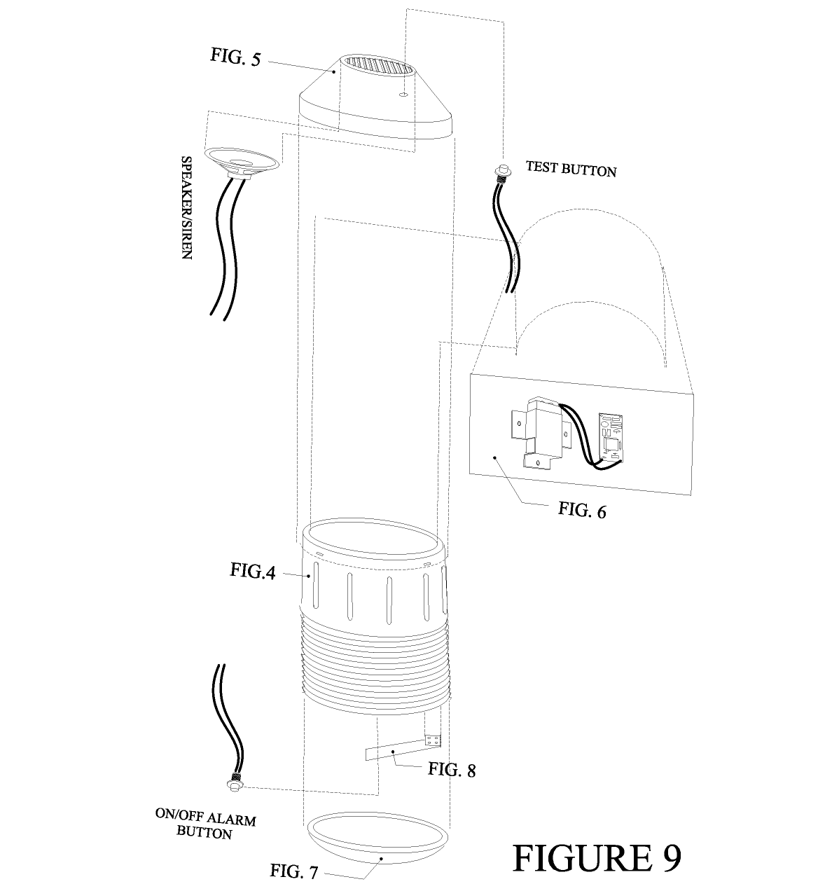

Referring to FIG. 9, illustrated as an exploded perspective view. This view shows how all the Figured drawings connect to each other.

While a particular form of the invention has been illustrated and described, it will be apparent that various modifications can be made without departing from the spirit and scope of the invention. Accordingly, it is not intended that the invention be limited, except as by the appended claims.

What is claimed is;

1. A device that is installed in the lowest point available on the sewer line used to alert the building owner that a sewer back-up situation has started.

2. This device is a low cost product that will be sold in plumbing supply retailers, etc. similar to how smoke detectors have been sold in the past.

3. It may be powered in several ways; 9 volt battery and plug in transformer are 2 basic methods.

4. Shape, size and color shall not change the basic function of the device.

5. This devise could be made to attach to a home security and alarm monitoring system.

6. This device could be attached to a smart phone application that would send an alert to your smart phone if alarm is sounded.
